(19) United States
(12) Patent Application Publication
(10) Pub. No.: US 2010/0073593 A1
(43) Pub. Date: Mar. 25, 2010

(54) LIQUID CRYSTAL DISPLAY DEVICE

(75) Inventors: Susumu SASAKI, Chiba (JP); Hitoshi Azuma, Yokohama (JP); Takao Ebine, Otaki (JP); Katsuyuu Takahashi, Mobara (JP); Tetsuya Nagata, Mobara (JP); Shigeki Nishizawa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/564,198

(22) Filed: Sep. 22, 2009

(30) Foreign Application Priority Data
Sep. 22, 2008 (JP) 2008-241998

(51) Int. Cl. G02F 1/1333

(52) U.S. Cl. 349/58

(57) ABSTRACT

A first outer surface is a convex surface, and constitutes a first cylindrical surface drawn by moving a first curved line defined on a flat surface P in the direction perpendicular to the flat surface P. A second outer surface is a concave surface and constitutes a second cylindrical surface drawn by moving a second curved line defined on the flat surface P in the direction perpendicular to the flat surface P. The second outer surface includes a pair of end areas drawn by moving the respective end portions of the second curved line and extending toward a middle side beyond the respective areas opposed to the seal, and a middle area drawn by moving the middle portion between the pair of end areas. The second support presses the pair of end areas, while avoiding the middle area.

### CROSS-REFERENCE TO RELATED APPLICATION

The present application claims priority from Japanese application JP2008-241998 filed on Sep. 22, 2008, the content of which is hereby incorporated by reference into this application.

### BACKGROUND OF THE INVENTION

1. Field of the Invention

The present invention relates to a liquid crystal display device.

2. Description of the Related Art

A liquid crystal display panel can be bent when, the glass substrate thereof is formed thin (Japanese Patent Laid-open Publication No. 2003-280548). The first and second glass substrates, which are opposed to each other, are securely fixed to each other along the end portions thereof. Therefore, when the first and second glass substrates are bent such that the outer surface of the former constitutes a convex surface and that of the latter constitutes a concave surface, a tensile force is applied to the former and a compressing force is applied to the latter. As a result, the second glass substrate has outward projection as releasing the compressing stress, and due to the projection, the distance between the opposed first and second glass substrates is widen, which influences the characteristic of the liquid crystal display panel.

### SUMMARY OF THE INVENTION

The present invention aims to prevent deterioration in characteristic of a liquid crystal display panel even when the panel is bent.
(1) According to one aspect of the present invention, there is provided a liquid crystal display device comprising: a liquid crystal panel having first and second substrates fixed to each other along end portions thereof by means of seal, liquid crystal enclosed between the first and second substrates, and first and second outer surfaces directed opposite from each other, and being bent; a first support for supporting the first substrate; and a second support for supporting the second substrate, wherein the first outer surface is a convex surface and constitutes a first cylindrical surface drawn by moving a first curved line defined on a flat surface in a direction perpendicular to the flat surface, the second outer surface is a concave surface and constitutes a second cylindrical surface drawn by moving a second curved line defined on the flat surface in the direction perpendicular to the flat surface, the second outer surface has a pair of end areas drawn by moving respective end portions of the second curved line and extending toward a middle side beyond areas opposed to the seal, a middle area drawn by moving a middle portion between the respective end portions of the second curved line, the second support presses the pair of end areas avoiding the middle area, and at least one of the first and second supports has light transmittance nature. According to the present invention, as the middle area on the concave surface of the bent liquid crystal panel is not supported, a compressing stress can be released. This makes it possible to suppress widening of the distance between the opposed surfaces of the first and second substrates.
(2) In the liquid crystal display device described in the above (1), the second support may have a third outer surface, and the third outer surface may be a convex surface and constitutes a third cylindrical surface drawn by moving a third curved line defined on the flat surface in a direction perpendicular to the flat surface.
(3) In the liquid crystal display device described in the above (1) or (2), the at least one of the first and second supports, which has the light transmittance nature may be placed covering the liquid crystal panel.
(4) In the liquid crystal display device described in the above (2), the third outer surface may have a larger curvature radius than that of the second outer surface.
(5) In the liquid crystal display device described in the above (2), the third outer surface may have a hole, the hole being formed in a portion which is opposed to the middle area.
(6) In the liquid crystal display device described in the above (2), the third outer surface may have a first curvature radius and a second curvature radius, the first curvature radius may be formed in a portion which is opposed to the middle area, the second curvature radius may be formed in portions which are opposed to the end areas, and the first curvature radius may be larger than the second curvature radius.

### BRIEF DESCRIPTION OF THE DRAWINGS

FIG. 1 is a cross sectional view of a liquid crystal display device according to an embodiment of the present invention;

FIG. 2 is a perspective view of the liquid crystal panel;

FIG. 3 is a cross sectional view of a modified example of a liquid crystal display device according to the embodiment of the present invention;

FIG. 4 is a cross sectional view of another modified example of a liquid crystal display device according to the embodiment of the present invention; and

FIG. 5 is a cross sectional view of yet another modified example of a liquid crystal display device according to the embodiment of the present invention.

### DETAILED DESCRIPTION OF THE INVENTION

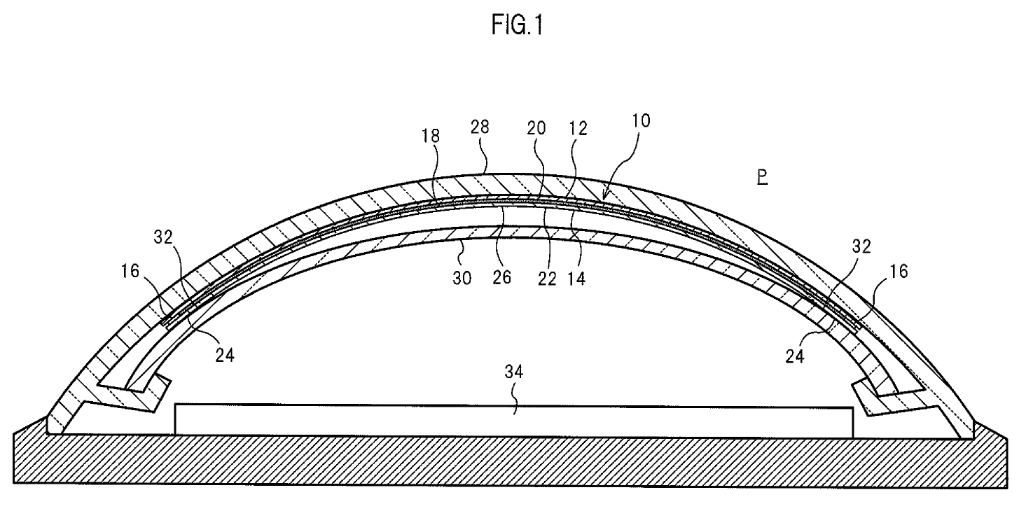

In the following, an embodiment of the present invention will be described with reference to the accompanying drawings. FIG. 1 is a cross sectional view of a liquid crystal display device according to an embodiment of the present invention. The liquid crystal display device has a liquid crystal panel 10.

The liquid crystal panel 10 comprises first and second substrates 12, 14, each of which has a glass substrate which is thin enough to bend. The first and second substrates 12, 14 may each have a polarizing plate provided outside the respective glass substrates, and are fixed to each other along the end portions thereof by seal 16 made of, e.g., epoxy resin. One of the first and second substrates 12, 14 is a TFT substrate where a TFT (Thin Film Transistor) (not shown) and wirings, or the like, are formed, and the other is a color filter substrate having a color layer (not shown) formed thereon.

Liquid crystal 18 is enclosed between the first and second substrates 12, 14. Abrading the first and second substrates 12, 14 to make the first and second substrates 12, 14 thinner after enclosing the liquid crystal 18 can reduce a possibility that the first and second substrates 12, 14 be broken.

The liquid crystal panel 10 has first and second outer surfaces 20, 22 directed opposite from each other. The first and second outer surfaces 20, 22 are the surfaces of the first and second substrates 12, 14, respectively. The first and second outer surfaces 20, 22 may be the surfaces of the glass substrates of the first and second substrates 12, 14, respectively, or those of the polarizing plates (not shown) provided outside the first and second substrates 12, 14.

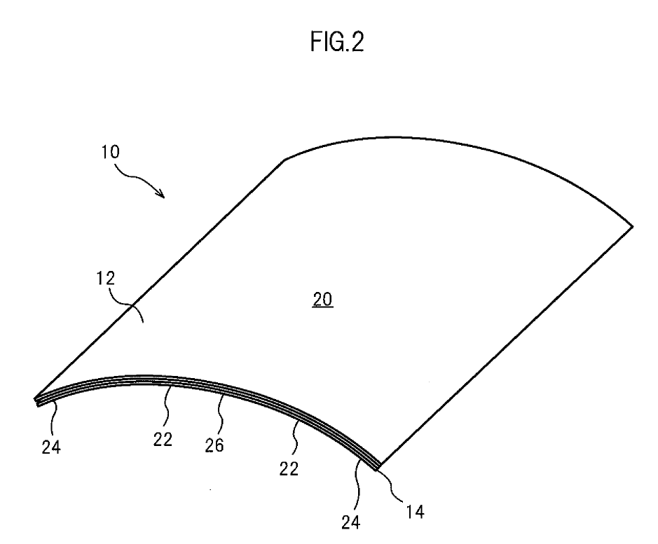

FIG. 2 is a perspective view of the liquid crystal panel. The liquid crystal panel 10 is bent. Specifically, the first outer surface 20 is a convex surface, constituting a first cylindrical surface drawn by moving a first curved line (the curved line indicating the first outer surface 20 in FIG. 1) defined on a flat surface P (the paper surface of FIG. 1) in the direction perpendicular to the flat surface P. Note that, according to Sugaku-Shojiten (Kyoritsu Shuppan Co., Ltd), a “cylindrical surface” is defined as a “curved surface drawn by moving a straight line along a curved line C defined on a flat surface so as to pass respective points on the curved line C, the straight line being perpendicular to the flat surface”.

The second outer surface 22 is a concave surface, and constitutes a second cylindrical surface drawn by moving a second curved line (the curved line indicating the second outer surface 22 in FIG. 1) defined on the flat surface P in the direction perpendicular to the flat surface P. The second outer surface 22 includes a pair of end areas 24 drawn by moving the respective end portions of the second curved line and extending toward the middle side of the second outer surface 22 beyond the respective areas opposed to the seal 16. The second outer surface 22 has a middle area 26 (an area between the pair of end areas 24) drawn by moving the middle portion between the respective end portions of the second curved line.

As shown in FIG. 1, a liquid crystal display device has a first support 28 for supporting the first substrate 12. Specifically, the first support 28 presses the liquid crystal panel 10 from the side of the first substrate 12 toward the side of the second substrate 14. The liquid crystal display device has a second support 30 for supporting the second substrate 14. Specifically, the second support 30 presses the liquid crystal panel 10 from the side of the second substrate 14 toward the side of the first substrate 12.

At least one of the first and second supports 28, 30 has light transmittance nature. The at least one (both in this embodiment) of the first and second supports 28, 30, which has the light transmittance nature is placed covering the liquid crystal panel 10.

The liquid crystal panel 10 is sandwiched between the first and second supports 28, 30. The above described bending of the liquid crystal panel 10 is realized thanks to the first and second supports 28, 30.

The first support 28 presses (e.g., contacts) the first outer surface 20 along the first outer surface 20 which is bent to project (as if the first support 28 had the same curvature radius as that of the first outer surface 20). The first supports 28 may press (or contact) the entire surface of the first outer surface 20. That is, the first supports 28 presses the middle portion of the first outer surface 20 as well.

The second support 30 has a third outer surface 32. The third outer surface 32 is a convex surface, and constitutes a third cylindrical surface drawn by moving a third curved line (the curved line indicating the third outer surface 32 in FIG. 1) defined on the flat surface P in the direction perpendicular to the flat surface P. The second support 30 (and the third outer surface 32 thereof) presses the pair of end areas 24, while avoiding the middle area 26 of the second outer surface 22 of the second substrate 14. In addition, the second support 30 presses areas of the second outer surface 22 of the second substrate 14, which are closer to the middle side of the second outer surface 22 (extending to the display area) beyond the respective areas opposed to the seal 16. That is, the third outer surface 32 is opposed to the seal 16 and also areas closer to the middle side of the second outer surface 22 beyond the seal 16 area.

For example, the third outer surface 32 of the second support 30 has a larger curvature radius than that of the second outer surface 22. With the above, at least one of the second support 30 and the second substrate 14 is deformed so as to be adapted to the curvature radius of the other. The end areas 24 of the second outer surface 22 are pressed by the second support 30, and a space is caused between the middle area 26 of the second outer surface 22 and the second support 30. As a modified example not shown, a portion of the second support 30, which is opposed to the middle area 26 of the second outer surface 22 may have a curvature radius different from that of the end areas 24 of the second outer surface 22. In this case, the curvature radius of the middle area 26 is larger than that of the end areas 24.

In this embodiment, as the middle area 26 on the concave surface of the bent liquid crystal panel 10 is not supported, a compressing stress can be released from the end portions toward the middle portion. Therefore, it is possible to suppress widening of the distance between the opposed surfaces of the first and second substrates 12, 14 in an area (particularly, in the end portions) of the liquid crystal panel 10.

### Modified Example

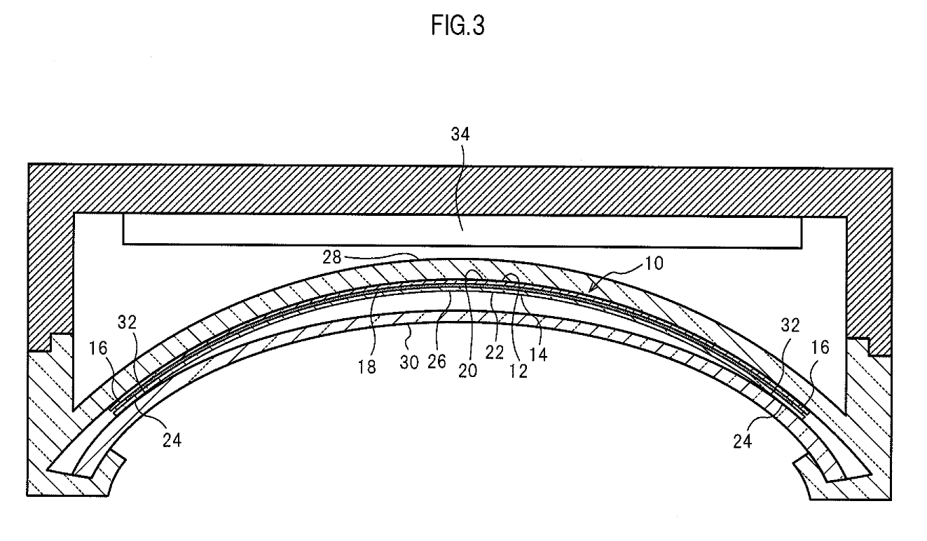

FIG. 3 is a cross sectional view of a modified example of a liquid crystal display device according to the embodiment of the present invention. In the example shown in FIG. 1, a backlight 34 is placed opposed to the second outer surface 22 which constitutes a concave surface of the second substrate 14. Meanwhile, in the example shown in FIG. 3, a backlight 34 is placed opposed to the first outer surface 20 which constitutes a convex surface of the first substrate 12. Accordingly, the structure of the housing in FIG. 1 differs from that in FIG. 3, with details of the difference being realized through application of publicly known art. As to other details of the liquid crystal display device shown in FIG. 3, the description concerning the above described embodiment is applicable.

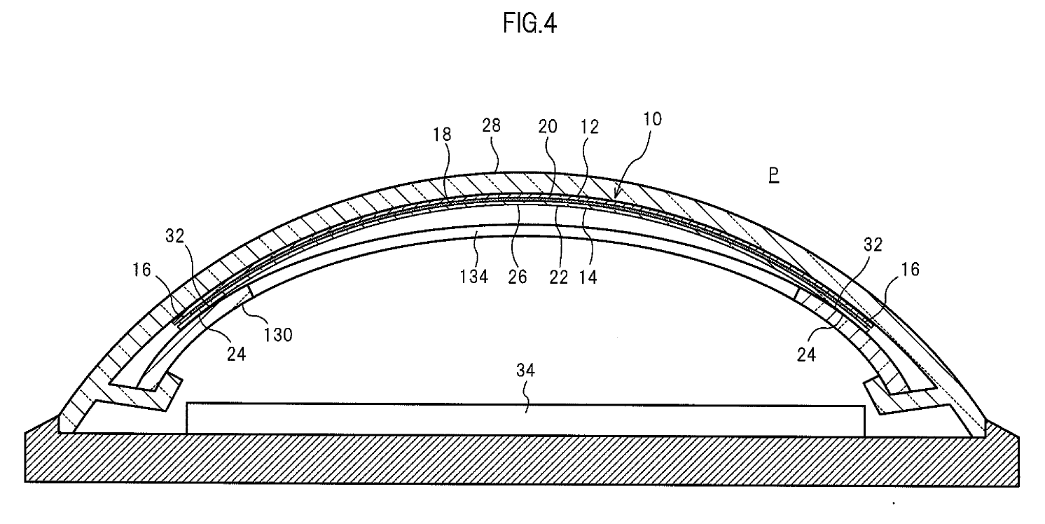

As another modified example shown in FIG. 4, a hole 134 may be formed in a portion of the second support 130. The hole 134 is opposed to the middle area 26 of the second outer surface 22.

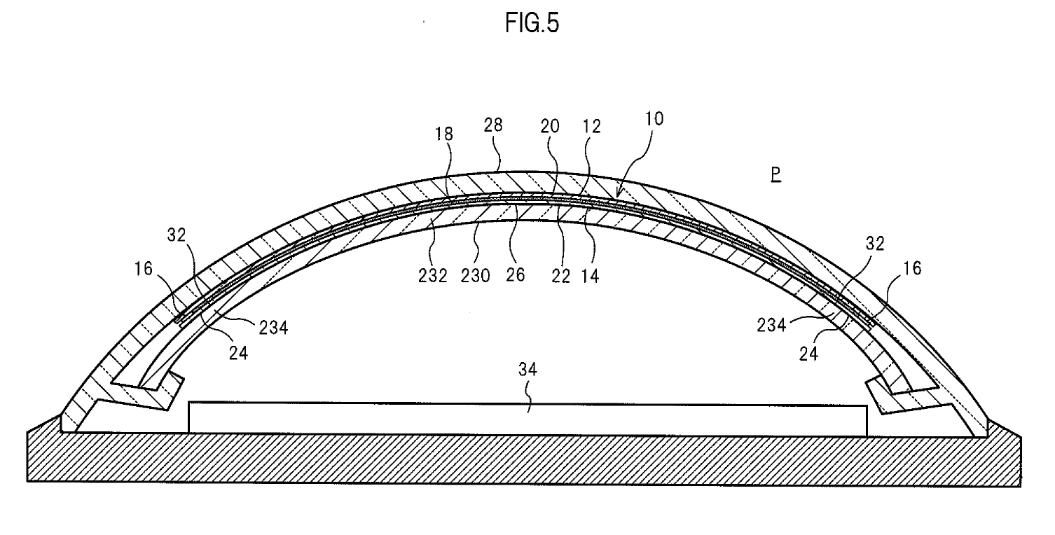

Alternatively, as shown in FIG. 5, a portion 232 of the second support 230, which is opposed to the middle area 26 of the second outer surface 22, has a first curvature radius. This first curvature radius is different from a second curvature radius of another portion 234 of the second support 230 which is opposed to the end area 24 of the second outer surface 22. The first curvature radius is larger than the second curvature radius.

A liquid crystal display device with the present invention applied thereto can be applied to, e.g., a game device. The present invention is not limited to the above described embodiment and can be modified in various manners. For example, the structure described in this embodiment can be substituted by a substantially identical structure or a structure producing an identical operational effect or achieving an identical object.

What is claimed is:

1. A liquid crystal display device, comprising:
a liquid crystal panel being bent and having first and second substrates fixed to each other along end portions thereof by means of seal, liquid crystal enclosed between the first and second substrates, and first and second outer surfaces directed opposite from each other;
a first support for supporting the first substrate; and
a second support for supporting the second substrate,
wherein
the first outer surface is a convex surface and constitutes a first cylindrical surface drawn by moving a first curved line defined on a flat surface in a direction perpendicular to the flat surface,
the second outer surface is a concave surface and constitutes a second cylindrical surface drawn by moving a second curved line defined on the flat surface in the direction perpendicular to the flat surface,
the second outer surface has a pair of end areas drawn by moving respective end portions of the second curved line and extending toward a middle side beyond areas opposed to the seal, and a middle area drawn by moving a middle portion between the respective end portions of the second curved line,
the second support presses the pair of end areas, while avoiding the middle area, and
at least one of the first and second supports has light transmittance nature.

2. The liquid crystal display device according to claim 1, wherein
the second support has a third outer surface, and
the third outer surface is a convex surface and constitutes a third cylindrical surface drawn by moving a third curved line defined on the flat surface in a direction perpendicular to the flat surface.

3. The liquid crystal display device according to claim 1, wherein the at least one of the first and second supports, which has the light transmittance nature is placed covering the liquid crystal panel.

4. The liquid crystal display device according to claim 2, wherein the at least one of the first and second supports, which has the light transmittance nature is placed covering the liquid crystal panel.

5. The liquid crystal display device according to claim 2, wherein the third outer surface has a larger curvature radius than that of the second outer surface.

6. The liquid crystal display device according to claim 2, wherein the third outer surface has a hole, the hole being formed in a portion which is opposed to the middle area.

7. The liquid crystal display device according to claim 2, wherein the third outer surface has a first curvature radius and a second curvature radius,
the first curvature radius is formed in a portion which is opposed to the middle area,
the second curvature radius is formed in portions which are opposed to the end areas, and
the first curvature radius is larger than the second curvature radius.
